(19) United States
(12) Patent Application Publication
(10) Pub. No.: US 2002/0075213 A1
(43) Pub. Date: Jun. 20, 2002

(54) Liquid crystal display device

(75) Inventors: Fang-Hvi Chan, Nantou Hsien (TW); Hsin-An Cheng, Kaohsiung Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: AU Optronics Corp.

(21) Appl. No.: 10/045,467

(22) Filed: Nov. 8, 2001

(30) Foreign Application Priority Data
Nov. 10, 2000 (TW) 89123797

(51) Int. Cl. G09G 3/36

(52) U.S. Cl. 345/87

(57) ABSTRACT

A liquid crystal display device is disclosed. The display device includes a first substrate and a second substrate facing the first substrate. A space for housing liquid crystal molecules is formed between the first substrate and the second substrate. The display device includes a plurality of liquid crystal molecules formed in the space in a predetermined arrangement, a first electrode with a first end and formed on the first substrate; and a second electrode with a second end and formed on the first substrate. A discharge gap is formed between the first end and the second end. When an external voltage is applied between the first and the second electrodes, an electrical field is generated to change the arrangement of the liquid crystal molecules. The display device fulfills the requirements for high quality LCD with a wide viewing angle and a high open ratio.

### BACKGROUND OF THE INVENTION

1. Field of the Invention

The present invention relates in general to a liquid crystal display (LCD) device with a wide viewing angle, more particularly to a display device with infinite domains.

2. Description of the Related Art

With the evolving progress in monitors and notebooks, the market for LCD devices is growing quickly. As LCD devices with large sizes and high resolution, wide viewing angles and fast response time become important factors among popular LCD devices. Besides of the color contrast inconsistency caused by viewing from different angles, the LCD gray scale, color saturation, and optical reactions are also important subjects relating to the LCD technology. In addition, the manufacturing cost is also a major concern for the LCD in the industry.

Most traditional LCD devices are designed in a twisted nematic (TN) type. The LCD device includes a LCD panel and two crossed polarizers adhered to the two sides of the LCD panel. The traditional LCD device has the drawbacks of narrow viewing angles (about 3020 vertically and 40° horizontally), a slow response time, and a high color dispersion. Meanwhile, problems are also encountered in the rubbing procedure for controlling the orientation of the liquid crystal molecules during mass production. The LCD devices are easily damaged by the electrostatic discharge and the particle pollution.

In order to meet the demand for LCD devices with wide viewing angles, a LCD panel with multiple domains and vertical aligned liquid crystals molecules have been developed. With the compensation film and the polarizers attached to both sides of the LCD panel, the liquid crystal molecules in each domain is vertically-aligned at different angles so that wide viewing angles and a low color dispersion are achieved. Additionally, the rubbing procedure is not needed for the LCD device described above, ESD damage and micro-particle pollution will not happen.

Several different structures for conventional vertically-aligned LCD devices with multiple domains have been designed. For example, IBM (International Business Machine) proposes a ridge-and-fringe-field vertical aligned structure. As shown in FIG. 1, the bumps structure of Y and the inversed-Y are formed on the center location of the pixel electrode. And in Fujitsu's multi-domain vertical-aligned structure, as shown in FIG. 2, the bump structures of W-shape is formed on both the upper and lower substrates. The addition of the bump structure on both the upper and lower substrates will increase the manufacturing capital, although the rubbing procedure is skipped. Moreover, such configuration of the bump and the electrode both located at the center of the pixel will also reduce the open ratio of the display.

There are also many types of multi-domain structures in LCD devices of in-plane switch (IPS) mode. Basically, the display cell is divided into multiple domains with the electrodes, and each domain is applied with a voltage field, thus achieving wide viewing angles. However, electrodes located in the display cell will reduce light transmittance. Conventional IPS mode LCD devices all suffer from small open ratio and inadequate brightness.

### SUMMARY OF THE INVENTION

An object of the present invention is to provide a liquid crystal display device with a high open ratio and indefinite domains to achieve maximum brightness and ultra-wide viewing angles.

According to the object, the present invention provides a space of liquid crystal molecules and at least an electrode pair with the end-to-end configuration. A space is located between two substrates to contain a plurality of liquid crystal molecules in a predetermined arrangement. The electrodes are formed to change the orientation of the liquid crystal molecules. Before being affected by the generated electric field, the arrangement of the liquid crystal molecules can be either vertical or horizontal. In other words, the present invention can be in IPS mode or VA (Vertically Aligned) mode.

The advantage of the present invention is that the end-to-end configured electrode pair can generate an electric field varied according to different positions. If one orientation of an electric field represents a domain, the present invention provides infinite numbers of domains for achieving wide viewing angles. Moreover, the electrodes only occupy minimal area in the display cell, so the open ratio of the display is dramatically increased. The brightness of the LCD panel is thus enhanced.

### BRIEF DESCRIPTION OF THE DRAWINGS

The present invention can be more fully understood by reading the subsequent detailed description in conjunction with the examples and references made to the accompanying drawings, wherein:

FIG. 1 is a conventional ridge-and-fringe-field vertical alignment structure;

FIG. 2 is a conventional multi-domain vertical-aligned structure

FIG. 3 is a perspective diagram of the LCD of the present invention;

FIG. 4A is the top view of FIG. 3;

FIG. 4B is the cross-section diagram along line bb′ of FIG. 4A;

FIG. 4C is the cross-sectional diagram along line aa′ of FIG. 4A;

FIG. 5A is the top view of the liquid crystal molecules with horizontal arrangement in the display cell of the present invention when no external voltage is applied;

FIG. 5B shows the arrangement of the liquid crystal molecules when an external voltage is applied;

FIG. 6A is the cross-sectional view of the liquid crystal molecules in a vertical arrangement in the present invention, when no external voltage is applied across the electrode pair;

FIG. 6B is a diagram of liquid crystal molecules when an external voltage is applied in FIG. 6A;

FIGS. 7A to 7D are the four possible designs of the electrode pair;

FIG. 8 is the top view of the multi-electrode pairs of the present invention;

FIG. 8B is the cross-sectional diagram of FIG. 8A along line aa;

FIG. 9A shows the electrode pair of the present invention located in the center of the display cell;

FIG. 9B shows the electrode pairs located at the corners of the display cell;

FIGS. 10A and 10B represent the top view and the cross-sectional view of the electrode pairs parallel to each other;

FIG. 11 shows a perspective diagram of an electrode pair in the display cell of the present invention

### DETAILED DESCRIPTION OF THE PREFERRED EMBODIMENT

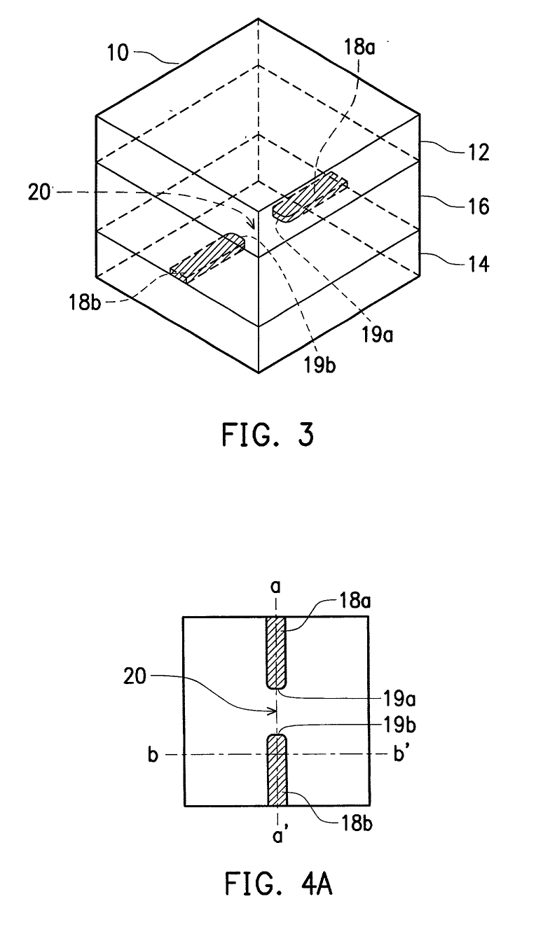

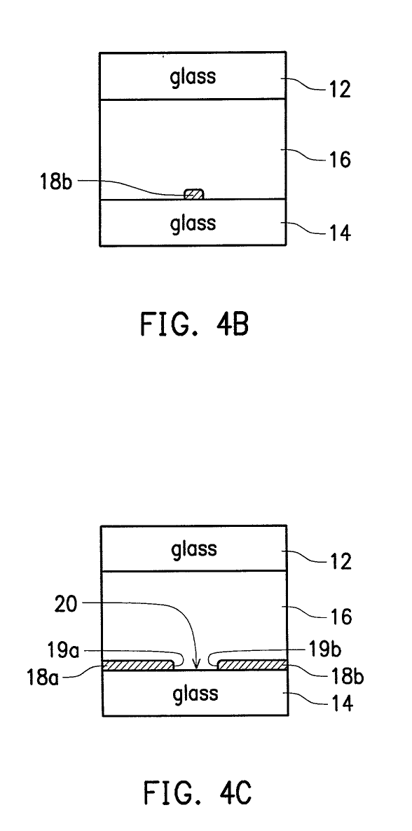

FIG. 3-FIG. 4C show the different views of the liquid crystal display (LCD) 10 of the present invention. FIG. 3 is a perspective diagram of the LCD, FIG. 4A is the top view of FIG. 3, FIG. 4B is the cross-section diagram along line bb′ of FIG. 4A, and FIG. 4C is the cross-section diagram along line aa′ of FIG. 4A. The display 10 of the present invention includes a first substrate 12, a second substrate 14, a first electrode 18a, and a second electrode 18b. A space 16 is formed between the first substrate 12 and a second substrate 14 for housing liquid crystal molecules. Two polarizers and compensation films can be disposed at the outsides of the first and second substrate 12, 14. The space 16 for containing liquid crystal molecules 17 is sandwiched between the two substrates 12 and 14. Moreover, the first and second electrodes 18a, 18b are in an end-to-end arrangement with a predetermined distance. When an external voltage is applied between the first and second electrodes 18a and 18b, an electric field in the space 16 is generated to change the orientation of the liquid crystal molecules 17.

The first and second electrodes 18a and 18b are formed on the same substrate. The first electrode 18a includes a first end 19a and the second electrode 18b includes a second end 19b. The distance between the first end and second end 19a and 19b is defined as a discharge gap 20. When an external voltage is applied between the first and the second electrodes 18a and 18b, an electric field will be generated and the orientation arrangement of the longitudinal axes of the liquid crystal molecules 17 will be changed by the electric field. In the predetermined arrangement, the original orientation of the liquid crystal molecules 17 can be either parallel or perpendicular to the first substrate 12 or the second substrate 14.The substrates 12 and 14 are made of glass. The electrodes 18 can be either opaque such as Cr or transparent such as ITO. ITO is a better choice for increasing the open ratio.

### The First Embodiment

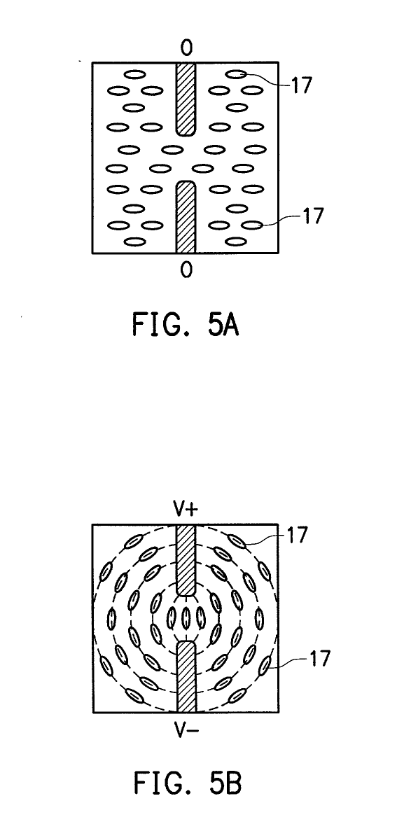

FIG. 5A is the top view of an embodiment having the liquid crystal molecules 17 with horizontal arrangement when no external voltage is applied. FIG. 5B is the view of the liquid crystal molecules 17 when an external voltage is applied, in contrast to FIG. 5A.

The present invention can be also applied to IPS mode LCD. When the dielecric constant difference Δ∈(=∈∥−∈⊥) of the liquid crystal molecules is greater than zero, the longitudinal axis of the liquid crystal molecules will be parallel to the direction of the electrical field. In FIG. 5, the longitudinal axes of the liquid crystal molecules are horizontal due to the rubbing operation on the PI layer when no external voltage is applied. When an external voltage is applied between the first and the second electrodes 18a, 18b, an electrical field is generated as the dotted line in FIG. 5B. After the orientations of the liquid crystal molecules 17 are changed, the light can penetrate through the LCD 10.

The alignment orientation of the liquid crystal molecules in the space 16 is changed along the electric field. If one orientation of a liquid crystal molecule represents a domain, there are infinite domains in the display 10. The more liquid crystal domains with different orientations are generated in the display, the fewer visual discrepancies will occur between different viewing angles. Thus, a wide viewing angle is achieved by increasing domains. On the other hand, the first and second electrodes 18a, 18b just occupy a small region of the display 10 so that only a small amount of light is shielded by the electrodes. Therefore, in contrast with conventional IPS mode LCD in which the display is divided by the electrodes into multiple domains, the present invention increases the open ratio significantly.

### The Second Embodiment

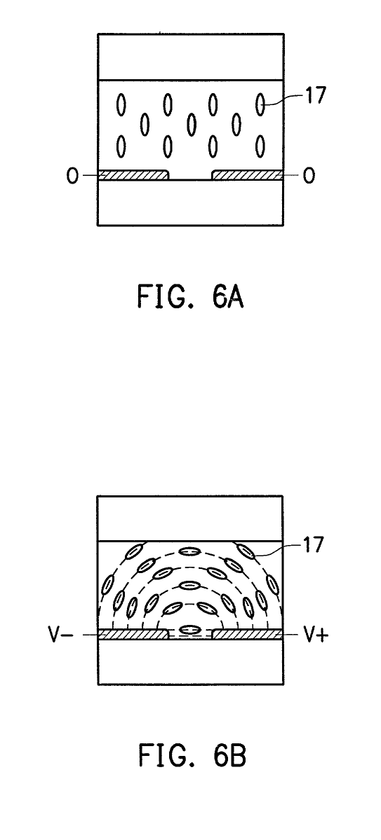

FIG. 6A is a cross-sectional view of the liquid crystal molecules 17 in a vertical-aligned arrangement in the present invention with no external voltage is applied. FIG. 6B is a diagram of liquid crystal molecules 17 when an external voltage is applied between the first and second electrodes 18a, 18b.

When no external voltage is applied, the longitudinal axes of the liquid crystal molecules 17 are vertical to the substrates 12, 14. When external voltage is applied, an electric field is generated as shown in FIG. 6B. The electric field lines look like a semi-spherical shape. The orientation change of the liquid crystal molecules 17 enables the light to penetrate through the space 16.

In addition to the same advantages of wide viewing angles and high open ratio in FIGS. 5A and 5B, the embodiment shown in FIGS. 6A and 6B offers a benefit of fast response time. The response time is about 50-60 ms as the liquid crystal molecules are twisted horizontally as shown in FIGS. 5A and 5B. Further, the response time is reduced to about 5 ms when the liquid crystals are twisted vertically as shown in FIGS. 6A and 6B.

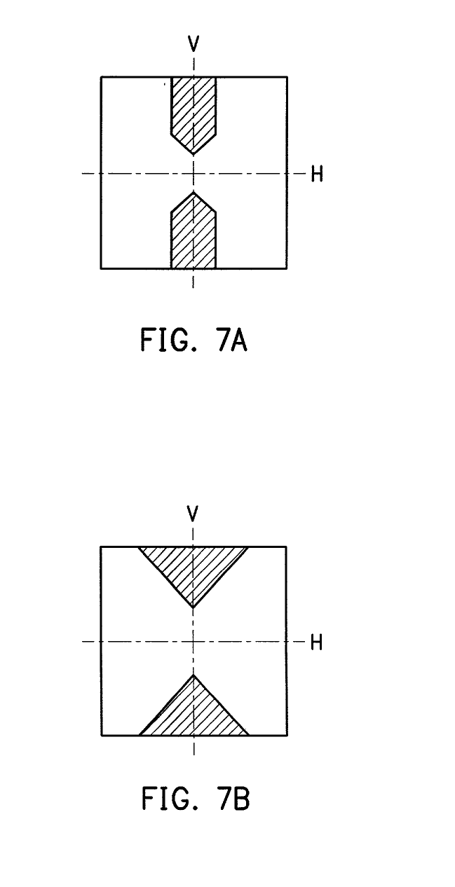

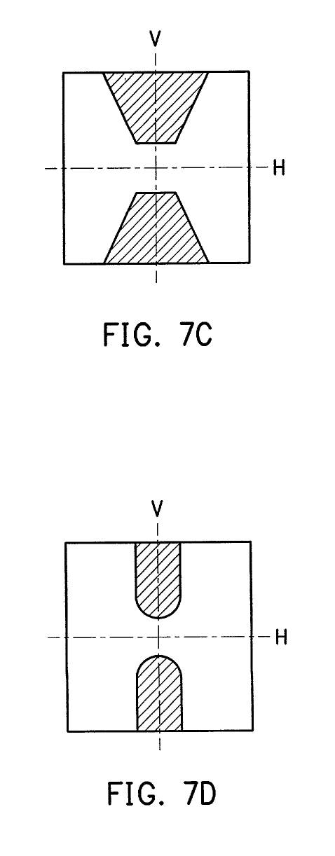

To achieve an uniform brightness at different viewing angles, the shape of the electrodes should be considered. FIGS. 7A to 7D are four possible designs of the electrodes. Basically, the two electrodes have the same shape, the electrodes can be symmetrical with respect to a horizontal line H. Additionally, each electrode should be laterally symmetrical for viewing from lateral angles, that is the electrode can be symmetrical to vertical line V as shown in FIGS. 7A to 7D.

### The Third Embodiment

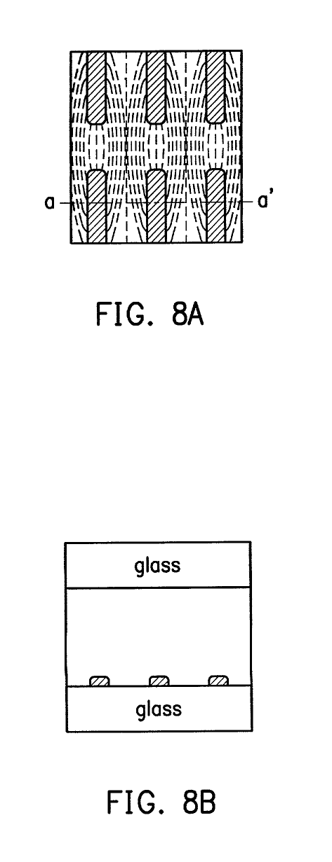

A plurality of electrode pairs with the end-to-end configuration can be used as shown in FIGS. 8A and 8B. FIG. 8A is the top view of the multi-electrode pairs in the present invention. FIG. 8B is the cross-sectional diagram of FIG. 8A along line aa′. The dotted lines represent the directions of the electric field. This embodiment can obtain a good optical property of wide viewing angle due to the multi-domain effect.

### The Fourth Embodiment

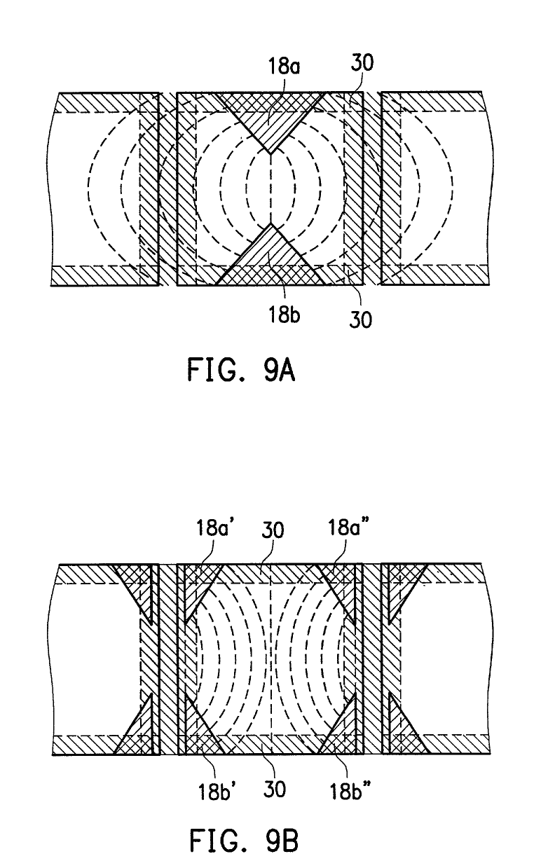

FIG. 9A is the embodiment showing the electrode pair located in the center of one cell in the display 10. FIG. 9B is the embodiment showing that the electrode pairs are located at the corners of one cell in the display 10. The pair of the electrode can be divided into four parts 18a′, 18a″, 18b′, 18b″, and placed at the corners of the cell. These four parts 18a′, 18a″, 18b′, 18b″ of the electrodes also have the end-to-end configuration as shown in FIG. 9B. The embodiment in FIG. 9B has the following advantages:

1. High open ratio: the light transmittance near the corners 30 of each display cell is always poor. By moving the electrodes to the corners of the display cell, the center area with high light transmittance will not be shielded by the electrodes, therefore, the open ratio will be increased.

2. The electric field does not affect adjacent display cells:

the electric field in FIG. 9A (represented with dotted lines) is an open electric field. When an external voltage is applied in one cell, the electric field will affect the liquid crystal molecules in the adjacent cells and transmit unwanted light in the adjacent cells. On the contrary, the electric field generated by the electrodes in the corners in FIG. 9B is maintain in the cell, and will not affect the liquid crystal molecules in the two adjacent display cells.

### The Fifth Embodiment

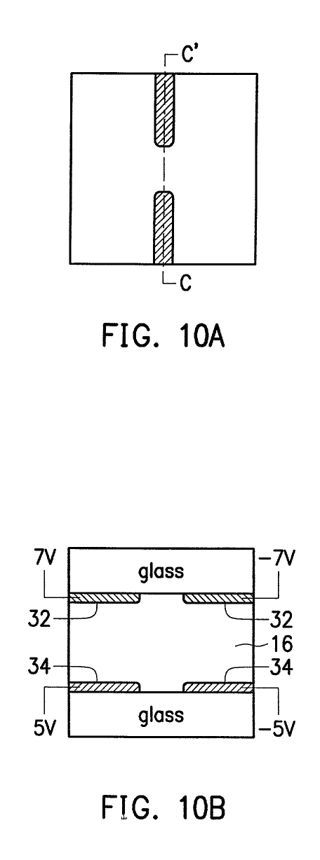

A display cell with two electrode pairs according to the present invention is shown in FIGS. 10A and 10B, representing the top view and the cross-sectional view respectively. The two electrode pairs 32 and 34 are disposed on the first and second substrates 12 and 14. Each electrode can be applied different voltage, such as 7V, 5V, −5V or −7V. The liquid crystal molecules 17 will rotate to different orientations according to the various voltage.

### The Sixth Embodiment

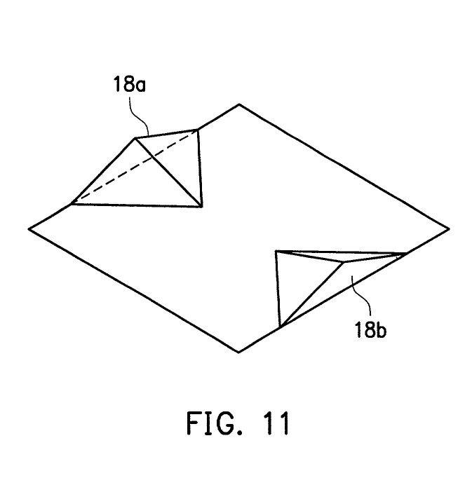

The shape of the electrodes can be modified to generate a more uniform and symmetrical electric field. FIG. 11 shows a perspective diagram of two electrodes of the present invention. The first and second electrodes 18a and 18b are thinnest at the ends where two electrodes are nearest to each other, and are thickest at the other ends.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

### Appendix A

### Version With Markings to Show Changes Made

Please amend the specification as follows:

### BRIEF DESCRIPTION OF THE DRAWINGS

The present invention can be more fully understood by reading the subsequent detailed description in conjunction with the examples and references made to the accompanying drawings, wherein:

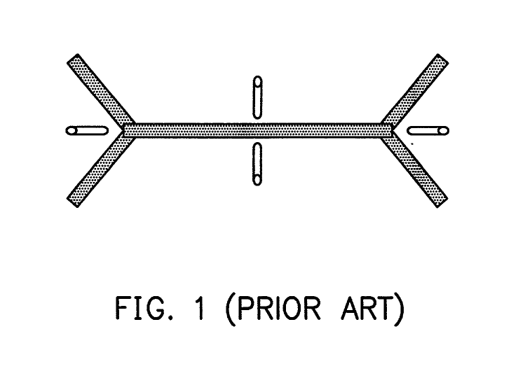

FIG. 1 is a conventional ridge-and-fringe-field vertical alignment structure;

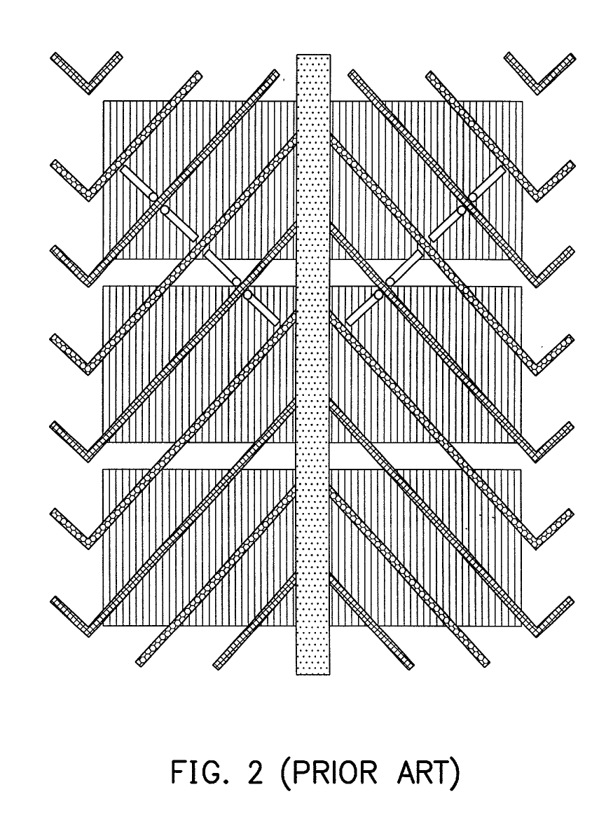

FIG. 2 is a conventional multi-domain vertical-aligned structure;

FIG. 3 is a perspective diagram of the LCD of the present invention;

FIG. 4A is the top view of FIG. 3;

FIG. 4B is the cross-section diagram along line bb′ of FIG. 4A;

FIG. 4C is the cross-sectional diagram along line aa′ of FIG. 4A;

FIG. 5A is the top view of the liquid crystal molecules with horizontal arrangement in the display cell of the present invention when no external voltage is applied;

FIG. 5B shows the arrangement of the liquid crystal molecules when an external voltage is applied;

FIG. 6A is the cross-sectional view of the liquid crystal molecules in a vertical arrangement in the present invention, when no external voltage is applied across the electrode pair;

FIG. 6B is a diagram of liquid crystal molecules when an external voltage is applied in FIG. 6A;

FIGS. 7A to 7D are the four possible designs of the electrode pair;

FIG. 8A is the top view of the multi-electrode pairs of the present invention;

FIG. 8B is the cross-sectional diagram of FIG. 8A along line aa;

FIG. 9A shows the electrode pair of the present invention located in the center of the display cell;

FIG. 9B shows the electrode pairs located at the corners of the display cell;

FIGS. 10A and 10B represent the top view and the cross-sectional view of the electrode pairs parallel to each other; and

FIG. 11 shows a perspective diagram of an electrode pair in the display cell of the present invention.

What is claimed is:

1. A liquid crystal display device comprising:
a first substrate;
a second substrate facing the first substrate, a space for housing liquid crystal molecules being formed between the first substrate and the second substrate;
a plurality of liquid crystal molecules formed in the space in a predetermined arrangement;
a first electrode with a first end, formed on the first substrate; and
a second electrode with a second end, formed on the first substrate, a discharge gap being formed between the first end and the second end;
wherein when an external voltage is applied between the first and the second electrodes, an electrical field is generated to change the arrangement of the liquid crystal molecules.

2. The liquid crystal display device of claim 1, wherein the predetermined arrangement of the liquid crystal molecules is in a vertical alignment, each liquid crystal molecule has a longitudinal axe, and the longitudinal axe is substantially perpendicular to the first substrate.

3. The liquid crystal display device of claim 1, wherein the predetermined arrangement of the liquid crystal molecules is in a vertical alignment, each liquid crystal molecule has a longitudinal axe, the longitudinal axe is substantially perpendicular to the second substrate.

4. The liquid crystal display device of claim 1, wherein the predetermined arrangement of the liquid crystal molecules is in a horizontal alignment, each liquid crystal molecule has a longitudinal axe, and the longitudinal axe is substantially parallel to the first substrate and perpendicular to a line formed by the first end and the second end.

5. The liquid crystal display device of claim 1, wherein the predetermined arrangement of the liquid crystal molecules is in a horizontal alignment, each liquid crystal molecules has a longitudinal axe, and the longitudinal axe is substantially parallel to the second substrate and perpendicular to a line formed between the first end and the second end.

6. The liquid crystal display device of claim 1, wherein a line is formed between the first end and the second end, and the first electrode is symmetrical to the second electrode by the line.

7. The liquid crystal display device of claim 1, wherein the display cell comprises a plurality of electrode pairs with an end-to-end arrangement, and the electrode pairs are parallel to each other.
